(19) United States
(12) Patent Application Publication
(10) Pub. No.: US 2005/0289463 A1
(43) Pub. Date: Dec. 29, 2005

(54) Systems and methods for spell correction of non-roman characters and words

(75) Inventors: Jun Wu, Los Altos, CA (US); Hongjun Zhu, Sunnyvale, CA (US); Huican Zhu, San Jose, CA (US); Wei-Hwa Huang, Mountain View, CA (US); Chiu-Ki Chan, Mountain View, CA (US)

Correspondence Address: Jung-hua Kuo;Attorney At Law, PO Box 3275, Los Altos, CA, 94024, US

(73) Assignee: Google Inc., A DELAWARE CORPORATION, Mountain View, CA (US)

(21) Appl. No.: 10/875,449

(22) Filed: Jun. 23, 2004

(51) Int. Cl. G06F 17/20; G06F 15/00

(52) U.S. Cl. 715/533; 715/530; 704/1; 704/9

(57) ABSTRACT

Systems and methods to process and correct spelling errors for non-Roman based words such as in Chinese, Japanese, and Korean languages using a rule-based classifier and a hidden Markov model are disclosed. The method generally includes converting an input entry in a first language such as Chinese to at least one intermediate entry in an intermediate representation, such as pinyin, different from the first language, converting the intermediate entry to at least one possible alternative spelling or form of the input in the first language, and determining that the input entry is either a correct or questionable input entry when a match between the input entry and all possible alternative spellings to the input entry is or is not located, respectively. The questionable input entry may be classified using, for example, a transformation rule based classifier based on transformation rules generated by a transformation rules generator.

### BACKGROUND OF THE INVENTION

1. Field of the Invention

The present invention relates generally to processing non-Roman based languages. More specifically, systems and methods to process and correct spelling errors for non-Roman based words such as in Chinese, Japanese, and Korean languages using a rule-based classifier and a hidden Markov model are disclosed.

2. Description of Related Art

Spell correction generally includes detecting erroneous words and determining appropriate replacements for the erroneous words. Most spelling errors in alphabetical, i.e., Roman-based, languages such as English are either out of vocabulary words, e.g., “thna” rather than “than,” or valid words improperly used in its context, e.g., “stranger then” rather than “stranger than.” Spell checkers that detect and correct out of vocabulary spelling errors in Roman-based languages are well known.

However, non-Roman based languages such as Chinese, Japanese, and Korean (CJK) languages have no invalid characters encoded in any computer character set, e.g., UTF-8 character set, such that most spelling errors are valid characters improperly used in context rather than out of vocabulary spelling errors. In Chinese, the correct use of words can generally only be determined in context. Thus an effective spell checker for a non-Roman based language should make use of contextual information to determine which characters and/or words in context are not suitable.

Spell correction for non-Roman languages such as CJK languages is also complex and challenging in that there are no standard dictionaries in such languages because the definition of CJK words are not clean. For example, some may regard “Beijing city” in Chinese as one word while others may regard them as two words. In contrast, the English dictionary/wordlist lookup is a key feature in English spell correction and thus English spell correction methods cannot be easily adapted for use in CJK languages. In addition, there are several thousand commonly used Chinese characters in contrast to the 26 letters in English thus making it impractical to replace incorrect characters in an illegal Chinese word by all alternatives and then to determine if the newly created word is appropriate. Furthermore, the Chinese language has a high concentration of homographs and homophones as well as invisible (or hidden) word boundaries that create ambiguities that also make efficient and effective Chinese spell correction complex and difficult to implement. As is evident with such differences between Chinese and English, many efficient techniques available for English spell correction are not suitable for Chinese spell correction.

Thus what is needed is a computer system and method for effective, efficient and accurate detecting and correcting of spelling errors in non-Roman languages such as Chinese, Japanese and Korean languages.

### SUMMARY OF THE INVENTION

Systems and methods to process and correct spelling errors for non-Roman based words such as in Chinese, Japanese, and Korean languages using a rule-based classifier and a hidden Markov model are disclosed. In particular, the systems and methods use transformation rules, hidden Markov models and similarity matrix of confusing characters. In a Chinese spell check application, the similarity between a pair of confusing characters may be a positive number if the characters have the same pronunciation and/or share some input keystrokes in simplified or traditional Chinese. Otherwise, the value is zero. In one implementation, the similarity may have a Boolean value, e.g., 1 for a pair of confusing characters and 0 for a pair of non-confusing characters. The systems and methods are particularly applicable to web-based search engines and downloadable applications at client sites, e.g., implemented in a toolbar or deskbar, but are applicable to various other applications. It should be appreciated that the present invention can be implemented in numerous ways, including as a process, an apparatus, a system, a device, a method, or a computer readable medium such as a computer readable storage medium or a computer network wherein program instructions are sent over optical or electronic communication lines. The term computer generally refers to any device with computing power such as personal digital assistants (PDAs), cellular telephones, and network switches. Several inventive embodiments of the present invention are described below.

The method generally includes converting an input entry in a first language such as Chinese to at least one intermediate entry in an intermediate representation, such as pinyin, different from the first language, converting the intermediate entry to at least one possible alternative spelling of the input in the first language, and determining that the input entry is either a correct or questionable input entry when a match between the input entry and all possible alternative spellings to the input entry is or is not located, respectively. As used herein, “pinyin” refers to all phonetic notations for Chinese, simplified or traditional, include zhuyin fuhao (Bopomofo), i.e., “The Notation of Annotated Sounds.” Similarity between pairs of confusing characters in the first language can be defined according to common tokens in the intermediate representation. The questionable input entry may be classified using, for example, a transformation rule based classifier based on transformation rules generated by a transformation rules generator. Various other classifiers such as decision tree and neural network classifiers may be similarly employed.

The converting may include converting multiple input entries, such as user queries in a query log. The method may further include classifying, e.g., by a transformation rule based classifier, the questionable entry as a correctly spelled or an incorrectly spelled entry based on a set of rules such as spell correction transformation rules. Users' votes, e.g., query logs and/or webpages, are preferably utilized to generate the transformation rules. The method may also include generating and training the spell correction transformation rules using a transformation rules generator using the questionable input entry and the possible alternative spellings. The method may further include receiving a user input in the first language, determining whether any of the rules apply to the user input, generating at least one alternate spelling in the first language corresponding to the user input upon determining that at least one rule applies to the user input, comparing a likelihood of the user input with a likelihood of at least one alternate spelling of the user input, and making a spell correction suggestion and/or a spell correction with at least one alternate spelling of the user input that has a higher likelihood than the user input.

A system generally includes a first converter configured to convert an input in a first language to at least one intermediate representation of the input entry, the intermediate representation being different from the first language, a second converter configured to convert the intermediate representation to at least one possible alternative spelling of the input in the first language, locating a match by comparing the possible alternative spelling to the input entry, and determining that the input entry is a questionable input entry if a match is not located from all the possible alternative spellings and that the input entry is a correct input entry if a match is located.

A computer program product for use in conjunction with a computer system, the computer program product having a computer readable storage medium on which are stored instructions executable on a computer processor, the instructions generally including receiving an input entry in a first language, converting the input entry to at least one intermediate representation of the input entry, the intermediate representation being different from the first language, converting the intermediate representation to at least one possible alternative spelling in the first language, locating a match by comparing at least one possible alternative spelling to the input entry, and determining that the input entry is a questionable input entry if a match is not located from all the possible alternative spellings and that the input entry is a correct input entry if a match is located.

An application implementing the system and method may be implemented on a server site such as on a search engine or may be implemented on a client site such as a user's computer, e.g., downloaded, to provide spell corrections for text inputting into a document or to interface with a remote server such as a search engine. The client site application may optionally include a user-editable table of stop rule patterns that allows the user to customize the application by specifying that certain spell corrections are disallowed, e.g., never replace X and Y except when X precedes or follows Z.

These and other features and advantages of the present invention will be presented in more detail in the following detailed description and the accompanying figures which illustrate by way of example principles of the invention.

### BRIEF DESCRIPTION OF THE DRAWINGS

The present invention will be readily understood by the following detailed description in conjunction with the accompanying drawings, wherein like reference numerals designate like structural elements.

FIG. 1 is block diagram of an illustrative system and method for performing forward and reverse conversions to and from an intermediate form of the non-Roman based language to determine possible alternate spellings for questionable original inputs.

FIG. 2 is block diagram of an illustrative system and method for generating spell correction transformation rules from a set of entries.

FIG. 3 is a flowchart illustrating a process for automatically generating spell correction transformation rules.

FIG. 4 is a flowchart illustrating a process utilizing the transformation rules for processing an entry to determine spell correction suggestions, if any.

### DESCRIPTION OF SPECIFIC EMBODIMENTS

Systems and methods to process and correct spelling errors for non-Roman based words such as in Chinese, Japanese, and Korean languages using a rule-based classifier and a hidden Markov model are disclosed. It is noted that for purposes of clarity only, the examples presented herein are applicable to Chinese spelling error detection and correction, and more particularly to simplified Chinese spelling error detection and correction. However, the systems and methods for spelling error detection and correction may be similarly applicable for other non-Roman based languages such as traditional Chinese, Japanese, Korean, Thai, etc. The following description is presented to enable any person skilled in the art to make and use the invention. Descriptions of specific embodiments and applications are provided only as examples and various modifications will be readily apparent to those skilled in the art. The general principles defined herein may be applied to other embodiments and applications without departing from the spirit and scope of the invention. Thus, the present invention is to be accorded the widest scope encompassing numerous alternatives, modifications and equivalents consistent with the principles and features disclosed herein. For purpose of clarity, details relating to technical material that is known in the technical fields related to the invention have not been described in detail so as not to unnecessarily obscure the present invention.

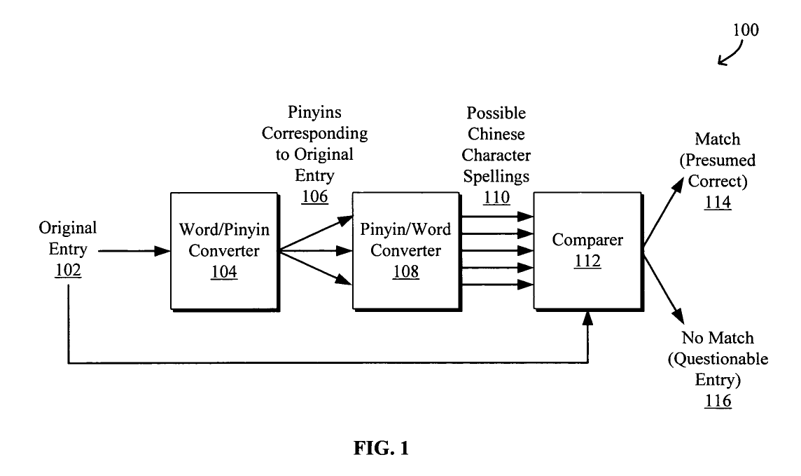

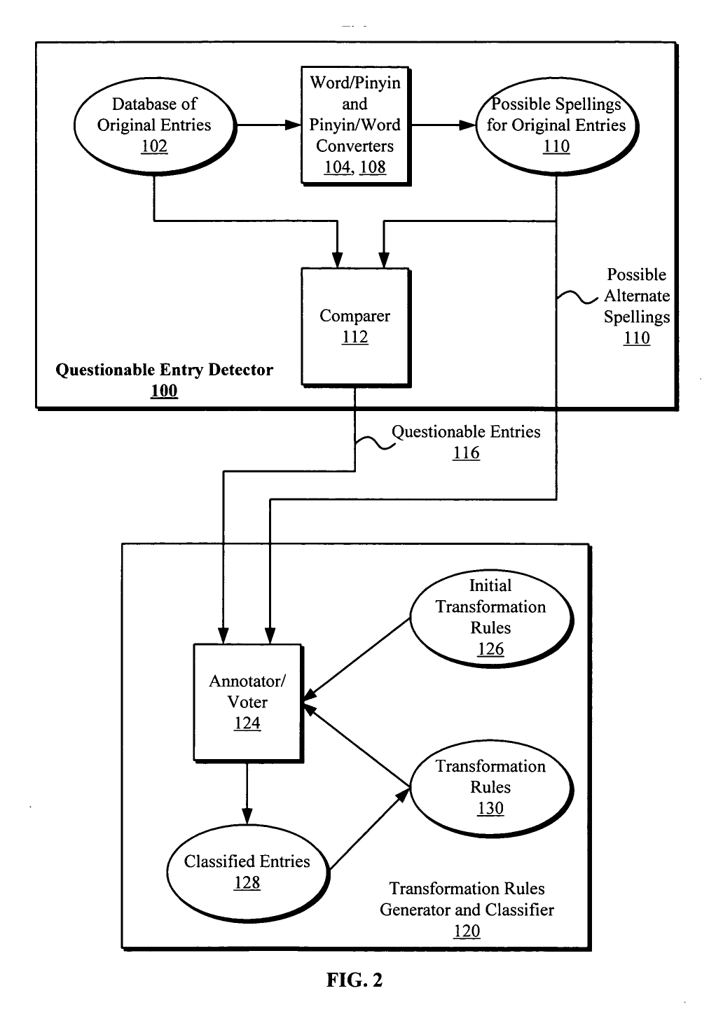

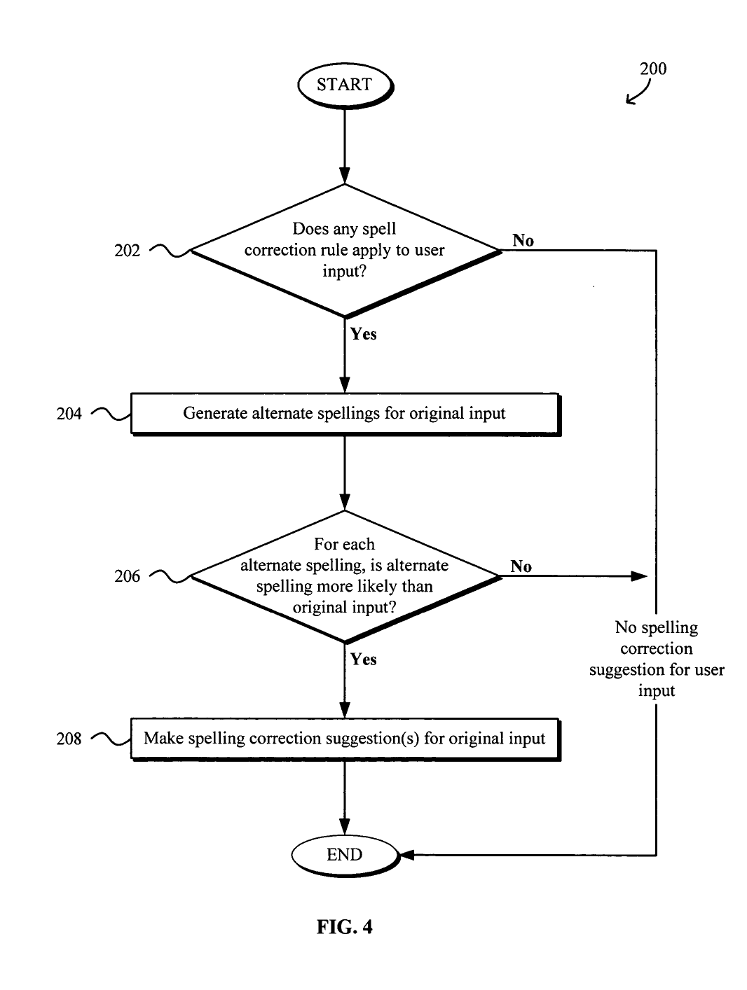

The systems and methods described herein generally relate to processing and correcting spelling errors in non-Roman languages using spell correction transformation rules generated from input entries. As used herein, the term “spelling” refers to both out of vocabulary characters or words as well as valid characters or words improperly used in context. In addition, the term alternate spelling or alternate form of an input is used herein to refer to an alternate set of characters and/or words different from the input but in the same language as the input, whether the input is a single character or word, a series or collection of characters and/or words, a phrase, a sentence, etc. The questionable input entries are identified from input entries and possible alternate spellings are generated by the questionable input entry detector illustrated in FIG. 1. Using the questionable input entries and the possible alternate spellings resulting from the questionable input entry detector as input, the spell correction transformation rules are then generated and trained and the questionable entries are classified as correct or incorrect by the transformation rules generator and classifier as shown in FIG. 2. The systems and methods use transformation rules, hidden Markov models and similarity matrix of confusing characters. In a Chinese application, the similarity between a pair of confusing characters may be a positive number if the characters have the same pronunciation and/or share some input keystrokes in simplified or traditional Chinese. Otherwise, the value is zero. In one implementation, the similarity may have a Boolean value, e.g., 1 for a pair of confusing characters and 0 for a pair of non-confusing characters. The process for identifying spelling errors and generating suggested spell corrections using the trained set of spell correction transformation rules is shown in the flowchart of FIG. 4. Thus by using a set of inputs to train the transformation rules, the most common spelling errors and corrections may be determined and processed to enhance the efficiency and effectiveness of the spelling check and correction system.

FIG. 1 is block diagram of an illustrative questionable input entry detector 100 for performing forward and reverse conversions to and from an intermediate form, e.g., pinyin, of simplified Chinese to identify questionable original inputs and to determine possible alternate spellings for questionable original inputs. The questionable input entry detector 100 illustrated in FIG. 1 makes use of the convenient fact that pinyin is a commonly-used input method for simplified Chinese. However, any other intermediate form, Roman-based or non-Roman based, may be implemented and utilized. Similarly, the questionable input entry detector 100 may be adapted for use with various other non-Roman based languages.

As shown in FIG. 1, a word-pinyin converter 104 converts each original entry 102 in Chinese characters into one or more pronunciations or pinyins 106 corresponding to the original entry 102. A pinyin-word converter 108 then converts the pinyins 106 to possible spellings 110 in Chinese characters. Other suitable converters 104, 106 for converting text in a first language to an intermediate representation and then back to the first language may be employed. Pinyin is merely a convenient intermediate representation for Chinese or simplified Chinese. A comparer 112 compares the original entry 102 with the possible spellings 110, both in the first language, to determine if there is a match. If the original entry 102 matches one of the possible spellings 110 output by the pinyin-word convert 108, the original entry 102 is matched assumed to be correctly spelled 114. However, if the original entry 102 does not match any of the possible spellings 110 output by the pinyin-word convert 108, the original entry 102 is a questionable entry 116, i.e., one that may be incorrect.

Pinyin is a phonetic input method used mainly for inputting simplified Chinese character. As referred to herein, pinyin generally refers to phonetic representation of Chinese characters, with or without representation of the tones associated with the Chinese characters. In particular, “pinyin” refers to all phonetic notations for Chinese, simplified or traditional, include zhuyin fuhao (Bopomofo), i.e., “The Notation of Annotated Sounds.”

Pinyin uses Roman characters and has a vocabulary listed in the form of multiple syllable words. Because Chinese has numerous homographs and homophones, each original entry 102 may be converted into multiple pinyins 106 by the word-pinyin converter 104 and, similarly, each pinyin 106 may be converted into multiple possible spellings in Chinese characters 110 by the pinyin-word converter 108. In particular, as there are only approximately 1,300 different phonetic syllables (as can be represented by pinyins) with tones and approximately 400 phonetic syllables without tones representing the tens of thousands of Chinese characters (Hanzi), one phonetic syllable (with or without tone) may correspond to many different Hanzi. For example, the pronunciation of “yi” in Mandarin can correspond to over 100 Hanzi. Thus the processes implemented by the word-pinyin converter 104 and the pinyin-word converter 108 of converting each original entry 102 to pinyin 106 and then back to Chinese characters 110 may be non-trivial given the large proportion of Chinese words that are homographs and/or homophones.

The systems and methods as described herein use transformation rules, hidden Markov models and similarity matrix of confusing characters. In a Chinese application, the similarity between a pair of confusing characters may be a positive number if the characters have similar pronunciation, share similar input keystrokes, and/or are similarly spelled, i.e., visually similar. Otherwise, the value is zero. In one implementation, the similarity may have a Boolean value, e.g., 1 for a pair of confusing characters and 0 for a pair of non-confusing characters. The similarity between a pair of confusing characters in the first language can be defined according to common tokens in the intermediate representation.

Various suitable mechanisms for converting Chinese words to pinyins and for converting pinyins to Chinese words may be implemented. For example, various decoders are suitable for translating pinyin to Hanzi (Chinese characters). In one embodiment, a Viterbi decoder using hidden Markov models may be implemented. The training for the hidden Markov models may be achieved, for example, by collecting empirical counts or by computing an expectation and performing an iterative maximization process. The Viterbi algorithm is a useful and efficient algorithm to decode the source input according to the output observations of a Markov communication channel. The Viterbi algorithm has been successfully implemented in various applications for natural language processing, such as speech recognition, optical character recognition, machine translation, speech tagging, parsing and spell checking. However, it is to be understood that instead of the Markov assumption, various other suitable assumptions may be made in implementing the decoding algorithm. In addition, the Viterbi algorithm is merely one suitable decoding algorithm that may be implemented by the decoder and various other suitable decoding algorithms such as a finite state machine, a Bayesian network, a decision plane algorithm (a high dimension Viterbi algorithm) or a Bahl-Cocke-Jelinek-Raviv (BCJR) algorithm (a two pass forward/backward Viterbi algorithm) may be implemented.

The questionable entries detected by the questionable input entry detector 100 generally include nearly all spelling errors. However, the questionable entries also generally include relatively high false-alarm/false-positive rate, i.e., ratio of the number of correct queries marked as incorrect to the number of incorrect queries. As will be described in more detail below, the questionable queries 116 as determined by the questionable entry detector 100 may then be classified as correct or incorrect. The classifier may be a Transformation Rule Based classifier, as is preferred, or may be a decision tree classifier, a neural network classifier, and the like. For entries classified as correct, no suggestions are made. For entries classified as incorrect, spell correction suggestions may be made depending on the likelihood of each possible alternative spelling.

FIG. 2 is block diagram of an illustrative system and method 120 for generating spell correction transformation rules from a set of original entries 102 as processed by the questionable entry detector 100. In particular, the set of original entries 102 may include user input entries such as query logs for a web search engine and/or entries derived from documents such as those available on the Internet, for example. In the case of user input entries, the set of original inputs 102 may include a collection of user queries from the past three weeks or two months, for example. Examples of documents may include web content and various publications such as newspaper, books, magazines, webpages, and the like. The set of original inputs 102 may be derived from a set, collection or repository of documents, for example, documents written in simplified and/or traditional Chinese available on the Internet. It is noted that the illustrative systems and methods as described herein are particularly applicable in the context of a web search engine and to a search engine for a database containing organized data. However, it is to be understood that the systems and method may be adapted and employed for various other applications for spelling error detection and correction, particularly for entries in a non-Romanized language. For example, the system and method may be adapted for a CJK text input application, e.g., word processing application, that detects and corrects spelling errors.

The transformation rules generator and classifier 120 implements a transformation based learning algorithm, introduced by Eric Brill, that, during the training process, automatically extracts (learns) and ranks transformation rules according to confidence measurements from training data, e.g., human annotated incorrect spellings. These transformation rules are used by the annotator/voter 124. Note that transformation rules are different from grammar rules used in linguistics in that the transformation rules are based on statistics rather than linguistic knowledge. Thus, for example, if most of the entries incorrectly spell certain words in the same incorrect way, the incorrect spelling would be classified as correct. Additional information on Transformation Rule Based methods is presented in U.S. Pat. No. 6,684201 issued on Jan. 27, 2004 to Eric Brill and entitled “Linguistic Disambiguation System and Method Using String-Based Pattern Training to Learn to Resolve Ambiguity Sites,” the entirety of which is incorporated by reference herein. Thus the transformation rules generator 120 generates rules automatically, i.e., unsupervised, by utilizing the users' votes. In other words, the correctness of a pattern of characters is determined according to the majority of votes in the database, e.g., the query logs, rather than human annotated data.

Each transformation rule is associated with a confidence measurement such that rules with higher confidence measurements are applied later than rules with lower confidence measurements. As an example, a first transformation rule may specify replacing X with Y if B precedes X. A second transformation rule with a higher confidence measurement may specify replacing Y with X if E follows Y. Thus the first transformation rule would first be applied to an entry BXE to generate BYE. The second transformation rule would then be applied to the resulting entry BYE to converted the entry back to BXE. As is evident, the order that the transformation rules are applied can affect the outcome. It is also noted that the characters being replaced and the replacement characters may be any component of the entry and need not necessarily be words. Similarly, the condition may be based on any context, part-of-speech tags or grammatical non-terminal labels (e.g., NP for noun phrase). It is further noted that although the Transformation Rule Based classifier is preferred, a naive Bayesian classifier, a decision tree classifier, a neural network classifier, or any of various other suitable classifiers may similarly be implemented to classify the questionable entries 116.

Returning to FIG. 2, as shown, each questionable entry 116 and its corresponding possible alternate spellings 110 output by the questionable entry detector 100 is received by the annotator 124 of the spell correction transformation rules generator 120. The annotator 124 classifies entries 128 based initially on the initial transformation rules 126 and eventually on the extracted and ranked transformation rules 130.

The learning phase may be supervised, i.e., by human personnel, and/or unsupervised. In one implementation, an initial set of a few common manually created transformation rules is used to automatically annotate a small set of questionable entries, with some human monitoring or without any human monitoring by utilizing users' votes. After the initial learning phase, additional transformation rules are generated, preferably also with some human monitoring, and additional questionable entries are annotated. The resulting rules which govern a significant amount of user traffic, for example, with relatively few rules may be regarded as very reliable and thus correspond to a high confidence measurement. Note that since rules with higher confidence typically have less coverage than those with lower confidence, both rules with high confidence and rules with comparatively lower confidence are used.

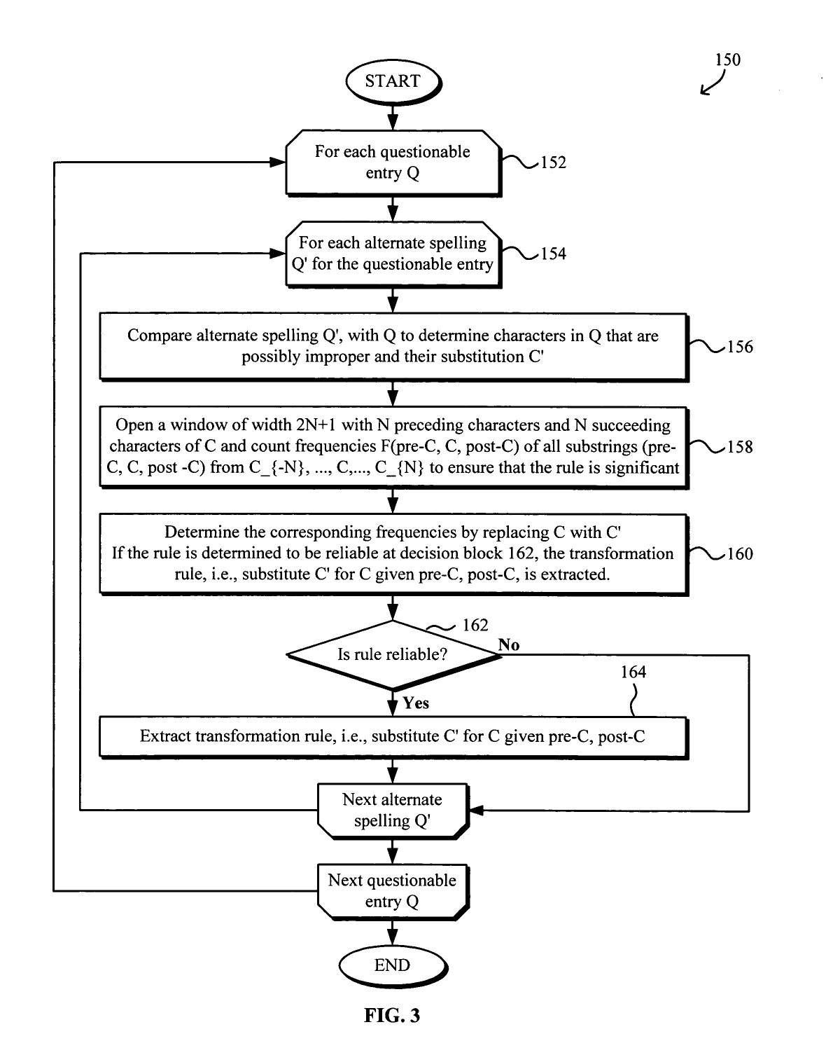

The relatively large number of remaining questionable entries that account for a relative small proportion of user traffic, for example, may be automatically generated without human monitoring, for purposes of cost efficiency. One illustrative process 150 for automatically generating such rules is shown in the flowchart of FIG. 3. In particular, for each questionable query Q at loop 152 and for each corresponding alternate spelling Q′ at loop 154, a comparison of Q and the alternate spelling Q′ is made at block 156 to determine characters in Q that are possibly improper and their substitutions C′. At block 158, a window of width 2N+1 is opened with N preceding characters and N succeeding characters of C. Note that any suitable length of context, e.g., 2N+1, may be implemented and the length of context before and after the character in question may but need not be equal. The frequencies F(pre-C, C, post-C) of all subsequences (pre-C, C, post-C) from C_{−N}, . . . , C, . . . , C_{N} are counted to ensure that the rule is significant, i.e., if the rule can cover a reasonable large portion of spelling errors in the questionable entries. A string S=xₛ₁, xₛ₂, . . . , xₛⱼ is a subsequence of string X=x₁, x₂, . . . xₖ, if 1≦s₁<s2 . . . <sj<k.

Next, at block 160, the corresponding frequencies by replacing C and C′ is determined. Decision block 162 then determines whether the rule is reliable, e.g., by using query logs and webpages, i.e., users' voting. If the rule is determined to be reliable, the transformation rule, i.e., substitute C′ for C given pre-C, post-C, is extracted. Specifically, the rule is deemed to be reliable if:
F(pre-C, C, post-C)>T1 and
F(pre-C, C′, post-C)/F(pre-C, C, post-C)>T2,
where T1 is a minimum significance threshold and T2 is a minimum confidence threshold. As noted above, the process 150 implemented by the transformation rules generator generates rules automatically, i.e., unsupervised, by utilizing the users' votes such that the correctness of a pattern of characters is determined according to the majority of votes in the database, e.g., the query logs, rather than human annotated data.

Because the most frequent transformation rules will govern a very large portion of the error patterns, the size of the rule set preferably does not increase rapidly with the number of questionable entries. A minimum occurrence of each rule may also be set to limit the size of the transformation rule set.

An application implementing the systems and methods described herein may be implemented on a server site such as on a search engine or may be implemented on a client site such as an end user's computer, e.g., downloaded, to provide spell corrections for text inputting into a word processing document or to interface with a remote server such as a search engine. The client site application may be implemented, for example, in a toolbar, and may optionally include a user-editable table of stop rule patterns that allows the user to customize the application by specifying that certain spell corrections are disallowed, e.g., never replace X and Y except when X precedes or follows Z. For example, some Chinese characters, such as “buy” and “sell,” have the same pronunciation “mai” (but different tones) and have almost the same syntactic role in the language yet have completely different meaning. Many automatic spelling rule generation programs tend to change either “buy” to “sale” or vice versa incorrectly. The end user may specify a stop rule “(X, Y)” in the stop rule pattern table to prevent the spell correction application from replacing X with Y.

FIG. 4 is a flowchart illustrating a process 200 utilizing the transformation rules for processing an entry to determine spell correction suggestions, if any. Decision block 202 determines if any spell correction rule applies to the user input. To perform decision block 202, a hash table of the spell correction transformation rules may be examined to determine if any transformation rule applies to the user input. For example, for a given Chinese user input ABCDE, if a transformation rule dictates that character C be replaced with C′ if the preceding characters to C are AB, then this particular rule is applicable to the user input. If no rules are applicable to the user input, no spell correction suggestion is made for user input. Alternatively, for each spell correction transformation rule that is applicable to the user input, alternate spellings for the user input corresponding to the applicable spell correction transformation rule are generated at block 204. In the example above, an alternate spelling ABC′DE is generated for the user input ABCDE corresponding to the applicable spell correction transformation rule.

At decision block 206, the likelihood of each alternate spelling is determined and compared to the likelihood of the user input. In one embodiment, decision block 206 may utilize the hidden Markov model and the Viterbi decoder to compute the likelihood. In the current example, the relative output probabilities of ABCDE and ABC′DE are determined and compared. The alternate spelling has a higher likelihood than the user input and thus regarded as a valid correction if:
P(ABC′DE)*P(transformation rule)>P(ABCDE),
where P(transformation rule) may be defined as the ratio of the number of successful corrections and the total number of corrections. Note that P(ABCDE) should take into account the ambiguity in segmentation. For example, if ABCDE has two possible segmentations AB-CDE and ABC-DE, then the probably is a sum of products of Bayesian probabilities:
P(ABC′DE)=P(input-end|CDE)*P(CDE|AB)*P(AB|input-beginning)+P(input-end|DE)*P(DE|ABC)*P(ABC|input-beginning).
Note that the equation above is a Bayesian probability derived from the original Bayesian probability by applying the Markov assumption which determines the current word by the preceding word rather than by the entire history. The determination of P(ABC′DE) may be similarly made.

If a given alternate spelling is not more likely than the user input as determined at decision block 206, the particular spell correction suggestion is not made. However, if the given alternate spelling is more likely than the user input as determined at decision block 206, the corresponding alternate spelling for the user's input is suggested and/or automatically made at block 208.

The systems and method for spell correction as described herein are particularly well suited for use with non-Roman based languages and can be highly effective in both detecting spelling errors and in generating alternate spelling suggestions or corrections. In addition, the systems and method for spell correction are also particularly applicable in the context of a web search engine and to a search engine for a database containing organized data in performing spell correction of various user inputs or queries.

While the exemplary embodiments of the present invention are described and illustrated herein, it will be appreciated that they are merely illustrative and that modifications can be made to these embodiments without departing from the spirit and scope of the invention. Thus, the scope of the invention is intended to be defined only in terms of the following claims as may be amended, with each claim being expressly incorporated into this Description of Specific Embodiments as an embodiment of the invention.

1. A method, comprising:
receiving an input entry in a first language;
converting the input entry to at least one intermediate entry in an intermediate representation different from the first language;
converting the intermediate entry to at least one possible alternative form of the input entry in the first language;
comparing the input entry to at least one possible alternative form of the input entry to locate a match; and
determining that the input entry is a questionable input entry based on the comparing.

2. The method of claim 1, wherein:
the intermediate entry is converted to more than one possible alternative forms of the input entry in the first language,
the comparing includes comparing the input entry to each possible alternative of the input entry in the first language, and
the determining includes determining that the input entry is a questionable input entry if a match is not located from all the possible alternative forms and that the input entry is a correct input entry if a match is located.

3. The method of claim 1, wherein the first language is a non-Roman based language.

4. The method of claim 1, wherein the first language is Chinese and the intermediate representation is pinyin.

5. The method of claim 1, wherein the input entry is a user query in a query log.

6. The method of claim 1, wherein the receiving includes receiving a plurality of input entries.

7. The method of claim 1, further comprising:
classifying the questionable entry as one of a correctly spelled entry and an incorrectly spelled entry based on a set of rules.

8. The method of claim 7, wherein the classifying is performed by a transformation rule based classifier.

9. The method of claim 7, wherein the rules are spell correction transformation rules, further comprising:
generating and training the spell correction transformation rules using a transformation rules generator using the questionable input entry and the at least one possible alternative form.

10. The method of claim 9, wherein the generating and training the spell correction transformation rules is performed automatically using a database of questionable input entries.

11. The method of claim 7, wherein the classifying is performed at least one of automatically and with manual monitoring.

12. The method of claim 7, further comprising:
receiving a user input in the first language;
determining whether any of the rules apply to the user input;
generating at least one alternate form in the first language corresponding to the user input upon determining that at least one rule applies to the user input;
comparing a likelihood of the user input with a likelihood of at least one alternate form of the user input; and
making at least one of a spell correction suggestion and a spell correction with at least one alternate form of the user input that has a higher likelihood than the user input.

13. The method of claim 12, further comprising:
maintaining a user-editable table of stop rule patterns that disallow the making of a spell correction suggestion or a spell correction for certain specified combinations of user input and alternate spelling.

14. A system, comprising:
a first converter configured to convert the input in a first language to at least one intermediate entry in an intermediate representation different from the first language;
a second converter configured to convert the intermediate entry to at least one possible alternative spelling of the input in the first language; and
a comparator configured to compare the input entry to at least one possible alternative spelling to locate a match, the comparator further being configured to determine whether the input entry is a questionable input entry based on the comparing.

15. The system of claim 14, wherein:
the second converter is configured to convert the intermediate entry to more than one possible alternative forms of the input entry in the first language,
the comparator is configured to compare the input entry to each of the at least one possible alternative of the input entry in the first language and to determining that the input entry is a questionable input entry if a match is not located from all the possible alternative forms and that the input entry is a correct input entry if a match is located.

16. The system of claim 14, wherein the first language is a non-Roman based language.

17. The system of claim 14, wherein the first language is Chinese and the intermediate representation is pinyin.

18. The system of claim 14, wherein the input entry is a user query in a query log.

19. The system of claim 14, further comprising:
a classifier configured to classify the questionable entry as one of correctly spelled entry and incorrectly spelled entry based on a set of rules.

20. The system of claim 19, wherein the classifier is a transformation rule based classifier.

21. The system of claim 19, wherein the rules of the classifier are spell correction transformation rules, the classifier further including a transformation rules generator for generating the spell correction transformation rules using the questionable input entry and the at least one possible alternative spelling of the input in the first language.

22. The system of claim 21, wherein the transformation rules generator generates the transformation rules automatically using a database of questionable input entries.

23. The system of claim 19, wherein the classifier performs at least one of automatically and with manual monitoring.

24. The system of claim 19, further comprising:
detector configured to determine whether any of the rules apply to a user input;
generator configured to generate at least one alternate spelling of the user input in the first language upon determining that at least one rule applies to the user input;
comparator configured to compare a likelihood of the user input with a likelihood of at least one alternate spelling of the user input; and
corrector configured to make at least one of a spell correction suggestion and a spell correction with at least one alternate spelling of the user input that has a higher likelihood than the user input.

25. The system of claim 24, further comprising:
customizable stop rule pattern table that disallows the corrector from making a spell correction suggestion or a spell correction for certain specified combinations of user input and alternate spelling.

26. A computer program product for use in conjunction with a computer system, the computer program product comprising a computer readable storage medium on which are stored instructions executable on a computer processor, the instructions including:
receiving an input entry in a first language;
converting the input entry to at least one intermediate entry in an intermediate representation different from the first language;
converting the intermediate entry to at least one possible alternative form of the input entry in the first language;
comparing the input entry to at least one possible alternative form of the input entry to locate a match; and
determining that the input entry is a questionable input entry based on the comparing.

27. The computer program product of claim 26, wherein:
the intermediate entry is converted to more than one possible alternative forms of the input entry in the first language,
the comparing includes comparing the input entry to each possible alternative of the input entry in the first language, and
the determining includes determining that the input entry is a questionable input entry if a match is not located from all the possible alternative forms and that the input entry is a correct input entry if a match is located.

28. The computer program product of claim 26, wherein the first language is a non-Roman based language.

29. The computer program product of claim 26, wherein the first language is Chinese and the intermediate representation is pinyin.

30. The computer program product of claim 26, wherein the input entry is a user query in a query log.

31. The computer program product of claim 26, wherein the receiving includes receiving a plurality of input entries.

32. The computer program product of claim 26, wherein the computer program product is implemented at a client site in a toolbar.

33. The computer program product of claim 26, the instructions further including:
classifying the questionable entry as one of correctly spelled and incorrectly spelled based on a set of rules.

34. The computer program product of claim 33, wherein the classifying is a transformation rule based classification.

35. The computer program product of claim 33, wherein the rules are spell correction transformation rules, the instructions further including:
generating and training the spell correction transformation rules using a transformation rules generator using the questionable input entry and the at least one possible alternative form.

36. The computer program product of claim 35, wherein the spell correction transformation rules are generated automatically using a database of questionable input entries.

37. The computer program product of claim 33, wherein the classifying is performed at least one of automatically and with manual monitoring.

38. The computer program product of claim 33, the instructions further including:
receiving a user input in the first language;
determining whether any of the rules apply to the user input;
generating at least one alternate form in the first language corresponding to the user input upon determining that at least one rule applies to the user input;
comparing a likelihood of the user input with a likelihood of at least one alternate form of the user input; and
making at least one of a spell correction suggestion and a spell correction with at least one alternate form of the user input that has a higher likelihood than the user input.

39. The computer program product of claim 38, the instructions further including:
maintaining a user-editable table of stop rule patterns that disallow the making of a spell correction suggestion or a spell correction for certain specified combinations of user input and alternate form.
